(19) United States
(12) Patent Application Publication
(10) Pub. No.: US 2021/0206402 A1
(43) Pub. Date: Jul. 8, 2021

(54) RAILWAY VEHICLE

(71) Applicant: Transit X, LLC, Allston, MA (US)

(72) Inventor: Michael David Stanley, Allston, MA (US)

(73) Assignee: Transit X, LLC, Allston, MA (US)

(21) Appl. No.: 16/735,525

(22) Filed: Jan. 6, 2020

(51) Int. Cl. B61F 5/38; B61B 3/00; B61F 3/08

(52) U.S. Cl. CPC B61F 5/383; B61F 3/08; B61B 3/00

(57) ABSTRACT

Vehicles for use on a railway and their methods of operation are disclosed. In one embodiment, a vehicle includes a bogie with wheels engaged with opposing tracks extending along a length of a railway the bogie travels along. The vehicle includes at least one sensor configured to sense a position of the bogie and/or wheels relative to the tracks of the railway. A processor of the vehicle uses the sensed position of the bogie and/or wheels relative to the tracks to steer the wheels of the bogie along a desired path on the tracks as the bogie travels along the railway.

### FIELD

Disclosed embodiments are related to railway vehicles and related methods.

### BACKGROUND

Railways are sometimes employed to facilitate the use of transportation networks for transportation systems such as trains, personal rapid transit systems, monorails, elevated rails, subways, and other rail based transportation systems. These conventional railways are typically formed using either a single railway or multiple parallel railways with each railway facilitating the movement of vehicles moving in either the same or opposing directions. Such systems typically employ passive steering mechanisms that rely on mechanical interactions between the wheels of the vehicles and the one or more tracks of each railway to steer the vehicle.

### SUMMARY

In one embodiment, a vehicle includes a bogie, at least one look ahead sensor, a vehicle body, and a processor. The bogie includes at least a first wheel and a second wheel coupled to a body of the bogie, wherein the first and second wheels are configured to engage with opposing tracks extending along a length of a railway as the bogie travels along the railway. The at least one look ahead sensor is configured to sense a position of the bogie relative to the tracks of the railway. The vehicle body is coupled to a bottom of the bogie body such that the vehicle body is configured to be suspended below the railway. The processor is configured to receive the sensed position of the bogie relative to the tracks of the railway from the at least one look ahead sensor. The processor is configured to determine a desired path of the first wheel and the second wheel on the tracks of the railway as the bogie travels along the railway based at least in part on the sensed position of the bogie relative to the tracks of the railway.

In another embodiment, a method of controlling a vehicle includes sensing a position of at least one wheel of the vehicle relative to at least one track of a railway on which the at least one wheel is disposed as the vehicle travels along the railway, determining a desired path of the at least one wheel along the at least one track, and steering the at least one wheel along the desired path as the vehicle travels along the railway.

In yet another embodiment, a vehicle includes a bogie configured to engage a railway, a vehicle body, and at least two connections extending between a top surface of the vehicle body and an opposing bottom surface of the bogie such that the vehicle body is suspended below the bogie when the bogie is engaged with the railway. The at least two connections are spaced apart along a longitudinal length of the bogie.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is a side view of one embodiment of an elevated railway;

FIG. 1B is a front view of the elevated railway of FIG. 1A;

FIG. 2 is a schematic of one embodiment of a vehicle and a vehicle control system;

FIGS. 3A-3C are schematics of alternative embodiments of a vehicle body;

FIG. 4A is a front view of one embodiment of a bogie;

FIG. 4B is a cross-sectional side view of the bogie of FIG. 4A;

FIG. 4C is an enlarged view of one embodiment of a connection associated with the bogie as shown in FIG. 4B;

FIG. 4D is a bottom view of the bogie of FIG. 4A;

FIG. 4E is a perspective view of the bogie of FIG. 4A;

FIG. 5A is a cross-sectional front view of one embodiment of a vehicle;

FIG. 5B is a cross-sectional side view of the vehicle of FIG. 5A;

FIG. 5C is a cross-sectional top view of the vehicle of FIG. 5A;

FIG. 5D is a perspective view of the vehicle of FIG. 5A;

FIG. 6A is a side view of another embodiment of a portion of a railway and associated vehicle;

FIG. 6B is a cross-sectional front view of the railway and vehicle of FIG. 6A;

FIG. 6C is a cross-sectional top view of the railway and vehicle of FIG. 6A;

FIG. 6D is an enlarged view of a portion of the railway and vehicle as shown in FIG. 6C;

FIG. 6E is an enlarged view of a portion of the railway and vehicle as shown in FIG. 6B;

FIG. 7A is a perspective view of one embodiment of a vehicle making a banked turn on a railway;

FIG. 7B is a front view of the banked turn of FIG. 7A;

FIG. 7C is an enlarged cross-sectional front view of a vehicle on a banked turn;

FIG. 8A is a top view of one embodiment of a bogie with steerable wheels;

FIG. 8B is an enlarged view of a portion of the bogie of FIG. 8A;

FIG. 9 is a top view of one embodiment of a bogie on a horizontally curved rail;

FIG. 10A is a front view of one embodiment of a bogie in a parked configuration;

FIG. 10B is a cross-sectional top view of the bogie of FIG. 10A;

FIG. 11A is a front view of one embodiment of a bogie on a rail;

FIG. 11B is a cross-sectional top view of the bogie of FIG. 11A;

FIG. 11C is an enlarged view of a portion of the bogie of FIG. 11A;

FIG. 11D is an enlarged view of another portion of the bogie of FIG. 11A;

FIG. 12A is a side view of one embodiment of a bogie on a vertically curved rail;

FIG. 12B is a side view of another embodiment of a bogie on a vertically curved rail; and

FIG. 13 is a flow chart for one embodiment of a method of controlling a vehicle.

### DETAILED DESCRIPTION

Conventional railway systems often rely on passive mechanisms to steer a vehicle along the tracks of a railway. The vehicle is often guided along the railway through interactions between the wheels of the vehicle and the associated tracks. Various designs have been employed for the interface between the wheels of the vehicle and the tracks of the rails with which the wheels engage. Typically, either the wheels or the rails (or both) are shaped to prevent derailment. Shaped rails have been used to passively guide vehicles with flat wheels, such as the L-shaped rails of early plateways designed to guide flat wagon wheels. Other previous systems have used grooved or shaped wheels. Some systems, such as conventional roller coasters, have used guide wheels that encompass a rail on more than one side of the rail.

In a conventional railway the rail-wheel interface is a steel wheel with a conical geometry that rides on a steel rail with a profile of an asymmetrical rounded I-beam. The complex dynamics between the shaped wheel and shaped rail enable a thin wheel to stay on a thin track. Friction between the wheels and the rail causes significant wear, leading to frequent maintenance for repair and/or replacement of critical components. Such passive systems have also been shown to suffer from instabilities such as hunting oscillations, which can lead to undesirable outcomes such as uncomfortable riding conditions or even derailment.

In view of the above, the inventor has recognized the benefits of a railway system with active correction of vehicle heading along the railway. Such a system may include vehicles with one or more flat wheels that engage with and travel along one or more corresponding flat tracks of the one or more rails of a railway. Sensors on the vehicle may detect a position of the wheels and/or bogie of a vehicle relative to the one or more tracks and/or a desired path along the tracks the wheels are engaged with. For example, the sensors may detect approaching curvature (or lack thereof) of a track ahead of the vehicle. This position and/or path related information may be used to actively steer the wheels of the vehicle to maintain the wheels on a desired path of travel along the tracks of the railway.

A railway system with active steering may provide many benefits. Active steering may obviate the need for passive control to guide the wheels of a vehicle along the one or more rails of a railway. Such a system may be generally simpler to maintain and repair, as there may be fewer overall components, and fewer physical interactions between the various components. Wear between components of the vehicle and components of the rail may also be reduced or eliminated. For example, such a system may eliminate most or even all wear between a wheel and a rail flange. This reduced wear may in turn lead to less maintenance, less downtime for repairs, and overall lower costs. A system without rail flanges may also achieve a higher efficiency, as rubbing between a wheel and a rail flange may waste energy through generated heat. Additionally, the life of the rails may be extended because a softer tire may be used where the tire may wear before the harder rail. Reduced wear on the rails may limit the amount and/or frequency that rails may need to be ground to reestablish the correct profile and/completely or replaced. Furthermore, a railway system with flat rails that interact with flat wheels may simplify the design of the intersection of rails at merge points where two rails merge together, leading to a smoother ride. Active steering may also eliminate the need for guide wheels, which may result in a system that is cheaper, lighter, smaller, and more efficient. Furthermore, active steering may reduce the potential for hunting oscillation, enabling a safer and smoother ride.

In some embodiments, a railway system includes a railway and a plurality of rail vehicles configured to travel along the railway. A vehicle may include a bogie and a vehicle body coupled to the bogie. The bogie may be configured to engage the railway through one or more wheels configured to engage with one or more tracks of the railway to enable the vehicle to travel along the railway. The vehicle body may be configured to hold passengers and/or cargo. The railway may be a grade-separated railway, such as an elevated railway, or the railway may be at or below grade, as the disclosure is not limited in this regard.

In some embodiments, a grade-separated railway includes a tubular rail and one or more poles coupled to the tubular rail that support the tubular rail above the ground. The one or more poles may be coupled to a side portion of the tubular rail such that the tubular rail is cantilevered from the pole, providing clearance for vehicles moving along the tubular rail. The tubular rail may include two parallel tracks formed inside of the tubular rail in the form of two flat surfaces extending along a length of the rail and located on opposing sides of a slot extending along the length of a bottom surface of the tubular rail. The two tracks may be located on a bottom interior side of the tubular rail. The wheels of a bogie may engage the tracks of the tubular rail. A vehicle body may be coupled to the bogie via a linkage extending through the slot, suspending the vehicle body above the ground. Thus, the wheels may be disposed on the tracks and the vehicle body may be suspended below the tubular railway via the linkage connected to the bogie.

A bogie may be configured to couple a vehicle body to a railway. As described above, a railway may be tubular in some embodiments. The bogie may be physically enclosed by the structure of the tubular rail, thereby reducing the possibility of vehicle derailment. However, embodiments in which a bogie is engaged with a railway other than a tubular rail, including non-enclosed (i.e. open, railways), are also contemplated. The bogie may include wheels, sensors, motors, batteries, actuators, processors, and/or any other appropriate component to permit an associated vehicle to move relative to a railway.

In some embodiments, a bogie includes an elongate body and a plurality of wheels. The body of the bogie may be coupled to a vehicle body. In some embodiments, such as in an elevated railway system, the vehicle body may be suspended from the body of the bogie such that the vehicle body is disposed below the bogie and associated tracks of a railway. The interface between the body of the bogie and the vehicle body may be standardized such that different vehicle bodies may be compatible with a single bogie.

A vehicle body may be coupled to a bogie through a connection disposed on the vehicle body. A connection may be a tab, a fin, a rod, an elongated projection, or any other suitably shaped structure with sufficient strength capable of connecting a vehicle body to an associated bogie while permitting the vehicle and bogie to travel along an associated railway, as the disclosure is not limited in this regard. A vehicle may include a single connection, or multiple connections, as the disclosure is not limited in this regard. In some instances, a bogie may include one or more recesses on the bottom side of the body of the bogie configured to receive connections disposed on the top of the vehicle body.

In some embodiments, a bogie includes at least two wheels. Wheels may be arranged in sets (such as pairs) disposed on opposing sides of the body of the bogie. For example, a bogie may include two sets of wheels where each set of wheels includes at least two wheels located on opposing sides of the body of the bogie. That is, a bogie may include four wheels arranged in two sets of wheels, with a first set of wheels located in a front portion of the body of the bogie and a second set of wheels located in a rear portion of the body of the bogie where the front and rear portions of the bogie are defined relative to a primary direction of travel of the vehicle which may be a front of the vehicle. Of course, other suitable numbers and/or arrangements of wheels may be appropriate, and the disclosure is not limited in this regard.

A wheel of a bogie may have any suitable geometry, shape, or size. In some embodiments, a wheel may include a flat surface that engages with a corresponding track. For example, a wheel may include a flat circumference, such that the diameter of the wheel along a surface that engages with a track during normal operation may not vary along an axial direction of the wheel. In some embodiments, the wheel may be configured to engage with a flat rolling surface, such as a flat track of a railway. Wheels with a flat surface that engages with a correspond track may be desirable in that such wheels may require less maintenance as compared to wheels with tapered or otherwise shaped wheels. Additionally, wheels with flat track engaging surfaces may enable a smoother transition at rail junctions.

In some embodiments, a wheel may be monolithic, and may comprise a single material. For example, a wheel may be made entirely of steel, although other materials such as other metals and/or appropriate polymeric materials are contemplated as the disclosure is not so limited. For instance, in some embodiments, a wheel may include a tire. A tire may be made of a different material than the wheel including, for example, a polymeric material with an appropriate hardness and durability. In some embodiments, the material of a tire may be selected to be higher friction material than the material of a rim of the wheel the tire is mounted on. In some embodiments, a tire may be made of a resilient material such as a high-density polyurethane plastic or a rubber. Other tire materials may be appropriate as the disclosure is not limited in this regard. Accordingly, it should be understood that a wheel may either be a monolithic structure made from a single material and/or it may include multiple materials and/or components made of any appropriate composition as the disclosure is not limited to any particular wheel construction.

A wheel may couple to the body of a bogie in any appropriate manner. In some embodiments, wheels may be arranged on one or more axles. The wheels may be coupled to the axles, and the axles may in turn be coupled to the body of the bogie. Such an arrangement may include pushrods, or other appropriate component, configured to pivot the wheels relative to the body of the bogie. In other embodiments, each wheel may be coupled directly to the body of the bogie. In such embodiments, independent pivoting control over each wheel may be possible.

In some embodiments, multiple connections may couple a vehicle body to a bogie. Each connection may be aligned with at least one of the wheels of the bogie. For example, a bogie may include a front set of wheels, with each wheel of the front set of wheels coupled to a front axle, and a rear set of wheels, with each wheel of the rear set of wheels coupled to a rear axle. Multiple connections between a bogie and vehicle body may be desirable in that multiple, short connections may be more stable in some applications. Additionally, multiple connections may allow a bogie to operate along a smaller rail slot (i.e., the slot between opposing tracks of a rail) compared to a bogie with a single, long connection. Thus, a vehicle body may be coupled to a bogie through two or more connections. In some embodiments, only two connections may be used. In some embodiments, a bogie may include four wheels on two axles, with a connection associated with each axle. For example, a connection may be centered at a longitudinal position of an adjacent axle. In some embodiments, a width of a connection in a lateral direction may be sufficiently small to be able to fit through a recess of the bogie. In some embodiments, a length of a connection in a longitudinal direction may be sufficiently large to enable sufficient structural strength. However, a length of a connection may not be too long as a longer connection may require a wider recess. In some instances, a front connection between a vehicle and bogie may be positioned within a desired distance of a front axle, or axis extending between the front wheels, and a rear connection between the vehicle and bogie may be aligned within a desired distance of a rear axle, or axis extending between the rear wheels. In some embodiments, a connection may be centered relative to the bogie body in a lateral direction. A preferred location in a longitudinal direction for the connection may be directly centered under an axle. In some embodiments, the connection may be offset from the axle due, for example, to space constraints. However, it may be desirable to minimize any offset distance, as a greater offset may require a wider recess to enable passage of the connection. For example, the connections may couple to the bogie at a predetermined distance offset from the axles of the bogie in the longitudinal direction. Alternatively, a connection may couple to a bogie at a distance offset from an axle in a direction toward the center of the bogie or in a direction toward an end of the bogie. That is, the distance between connections may be equal to, less than, or greater than the distance between axles of the bogie. The desired distance from each axle or axis extending between a pair of wheels may be measured in a neutral position when the wheels are not pivoted with respect to the body of the bogie.

In addition to the above, the multiple connections extending between a vehicle body and bogie may have any appropriate thickness and/or length for a desired application. However, in some embodiments, a connection extending between a vehicle body and a bogie may have a length in a direction parallel to a longitudinal axis of the bogie that is greater than or equal to 2.5% of the length of the bogie and/or less than or equal to 5.0% of the length of the bogie. For example, for a 2 m long bogie, a connection may be greater than or equal to 50 mm and less than or equal to 100 mm. However, connections with longitudinal lengths both greater and less than those noted above are also contemplated.

It should be understood that a vehicle body may be configured to couple to a bogie in any appropriate fashion. Further, the vehicle body may hold passengers and/or cargo. The vehicle body may also include a main chassis with one or more doors and/or windows. A vehicle body may be any suitable shape or size, as the disclosure is not limited in this regard. Thus, should be understood that a vehicle body may have any appropriate construction and it may be connected to a bogie in any appropriate fashion, which may include in some embodiments, a standard interface to permit different vehicle bodies to be easily attached to a bogie.

In some embodiments, protrusions may extend beyond the edge of a wheel in a direction away from a bogie body to prevent contact between the side of the wheel and a corresponding portion of a track or other adjacent portion of a railway. For example, a protrusion may be an extension of an axle, or a separate structure that extends outwards away from the wheel and bogie body that is independent of the axle. In some embodiments, the axle may be extended laterally outward beyond the edge of the wheel toward an associated rail flange and/or the sidewall of a railway or other adjacent structure. Thus, if the bogie rotates or is otherwise moved out of a desired position along a railway as might occur during a power or guidance failure, the protrusion, rather than the tire, may contact the sidewall of the railway, track flange, or other structure. Thus, the protrusion may passively guide the wheels along the associated tracks of a railway in some embodiments where the wheels are not being actively steered. The protrusions may be made of a harder, more wear-resistant material compared to the wheels, which may be made of a softer, more wear-prone material. It may be undesirable for a rubber tire to contact a rail, as the rubber tire may have a high coefficient of friction and may not easily slide along the wall. Thus, protrusions aligned with an axle of an associated wheel may be configured to contact a sidewall of a rail, track flange, or other structure at a. In contrast, a wheel may contact a sidewall at any vertical position along the sidewall. As such, protrusions may enable the use of spot welds or other fasteners on the rail at positions outside of the contact area of the protrusion and the sidewall. The contact area of a sidewall of a rail, a rail flange, or other structure may be made of a different material or may be coated in order to reduce friction between the protrusions and the structure. In some embodiments, a protrusion may have a rounded shape, thereby enabling minimal contact between the protrusion and the sidewall regardless of contact angle. Compared to a wheel, such a protrusion may experience significantly less friction.

In some instances, a vehicle may include one or more sensors. Sensors may provide information regarding: other vehicles in a railway system, such as their location or distance; and/or location, speed, and/or other information regarding the vehicle on the railway; and/or information regarding the railway itself and/or positioning of the vehicle or a bogie along the rail and/or a desired path along the rail; and/or any other appropriate information. For example, information regarding the curvature of one or more tracks of a railway ahead of a vehicle may be sensed. Additionally, a sensor may sense the position of the wheels of the bogie relative to the tracks of the railway. In some embodiments, a bogie may include one or more sensors configured to sense a position of the bogie relative to the tracks of the railway. In some embodiments, a sensor may be used to precisely measure the lateral position of the wheels on the tracks. For example, a sensor may sense a geometry of a rail such as a curvature of the rail, an edge of a track on a rail, a position of a wheel on a track of a rail, and/or any other appropriate information. Sensors may be disposed on a bogie near the front wheels, on a front portion of a bogie, near the rear wheels, and/or any other appropriate portion of the bogie. Sensors may be configured to sense a portion of the rail ahead of the bogie, a portion of the rail directly in front of one or more wheels of a bogie, and/or any other appropriate portion of the rail. In some embodiments, the one or more sensors may directly measure the lateral location of the associated one or more tracks relative to the bogie. The one or more sensors may use any appropriate edge finding sensor and/or method to identify an edge of a rail. In some embodiments, information from the one or more sensors may be used in conjunction with information regarding a width of a track, a desired offset from an edge of a track, and/or the identification of two opposing edges of a track in order to maintain a wheel at a desired position on the surface of a track. In some embodiments, a magnetic strip may be installed on the top of the rail so that a sensor mounted on the top of the bogie facing up may measure the distance to the magnetic strip. The sensors may include look ahead sensors, cameras, distance sensors, magnetic sensors, LIDAR, radar, or any other suitable sensors, as the disclosure is not limited in this regard. The sensors may be disposed on a body of the bogie, or may be associated with one or more wheels of the bogie. For example, each wheel may be associated with a look ahead sensor disposed above the wheel. Thus, it should be understood that the one or more sensors may be disposed on the bogie, on the vehicle body, or on any other suitable portion of the vehicle. Of course, other suitable placement of sensors may be appropriate as the disclosure is not limited in this regard. Further, in some embodiments, additional sensors may be disposed on the railway, and the sensors on the railway may interact with sensors on the vehicle and/or information may be transmitted to a processor of the vehicle from the sensors disposed on the railway.

As noted above, in some embodiments of the present disclosure, rail flanges may be used to help keep wheels on the rail. A rail flange may be a shaped structure disposed along the sides of an otherwise flat track that may provide a horizontal reaction force if a wheel, or other component associated with a bogie, travelling on the rail contacts the rail flange. In the present disclosure, if active steering brakes down, rail flanges may serve as a failsafe. A rail flange may bend and/or flex when contacted by a wheel, acting as a spring to return the wheel to the center of the rail though embodiments in which a relatively stiff structure is used are also contemplated. Use of rail flanges may obviate the need to use horizontally mounted guide wheels. In some embodiments, the sidewall of a tubular railway may act as a secondary flange in addition to a dedicated rail flange disposed on the track of the rail.

In some embodiments, a railway may include L-shaped tracks. L-shaped tracks may be subject to debris collecting in the railway. The inventor has recognized that there may be multiple ways in which issues related to debris collection may be mitigated. For example, in some embodiments, the wheels of a bogie may be solid which may create minimal dust and/or particulates during operation. Additionally, in some embodiments, the rails may be elevated off the ground and therefore accumulate much less debris than if the rails were on the ground. Further, motion of the wheel may generate sufficient air flow such that debris may be blown off the track. In some embodiments, a specialized cleaning vehicle may travel along the railway and wash the rails.

A bogie of a vehicle may be steered along the one or more tracks of a railway using any appropriate method. For example, active steering and high-speed line following using sensors and actuators may be used in some embodiments to guide the wheels of a bogie along a desired path of travel along the one or more tracks without the use of guide wheels or wheel flanges to passively steer the wheels. Steering of the bogie may be accomplished in at least two ways. First, differential wheel speeds may be used. Second, the wheels of the bogie may be configured to pivot relative to the body of the bogie. Each of these steering strategies are discussed further below. In both cases, the lag time between a steering command and its action may be considered when determining timing, direction, magnitude, and/or other operating parameters for a desired steering command. It should be appreciated that a combination of these steering strategies and/or other steering strategies may be employed as the disclosure is not limited in this regard.

In some embodiments, differential wheel speeds may be used to steer a bogie. For example, a bogie with four wheels may be able to independently control the speed and braking of each wheel. Steering may be accomplished by changing (i.e. increasing or decreasing) a power provided to the wheels and/or braking on one side of the bogie relative to the wheels on the opposing side of the bogie. The difference in speed between the opposing sides may cause the bogie to turn. The magnitude of the difference in power and/or a braking force between the right and left sides may affect how sharply the bogie will turn. In some embodiments, a bogie may include a long wheelbase and a short axle length. In such embodiments, differential wheel speeds may not allow for sharp turning. In other embodiments in which a bogie includes a shorter wheelbase and/or a longer axle length, sharper turning may be achieved through differential wheel speeds.

In some embodiments, wheels may be pivoted to steer a bogie. Each wheel of the bogie may be configured to pivot. For example, a bogie may include four wheels, with a pair of front wheels and a pair of rear wheels. Each pair of wheels may be connected with a rod such that the wheels of a pair pivot together. For example, a linear actuator may push and/or pull on the rod to steer. Though independently steerable wheels may also be used. The steering on the front wheels may be independent from the steering on the rear wheels. The front and rear wheels may turn in either the same direction or in opposite directions. If power or control is lost, the wheels may be configured to auto-center due to a biasing force that biases the wheels to a neutral straight orientation that steers the bogie in a straight line oriented with a primary direction of travel of the bogie when outside forces are not applied to the bogie.

In embodiments in which the wheels are pivotable, the steering on the front and rear wheels may enable a bogie to brake by turning the front wheels in one direction and the rear wheels in the opposite direction while on a straight segment of a rail. In such a configuration, the wheels may touch sidewalls of the rails at multiple points, thereby effectively applying a ‘parking brake’ or ‘emergency brake’ so that the bogie may be prevented from easily moving. Such a braking strategy may require no additional parts or mechanisms. This braking technique may be used while the bogie is moving, acting as an emergency brake. Additionally, the amount of braking may be proportional to the amount the wheels are turned. As such, the amount of braking may be adjusted depending on whether just the front wheels are engaged, just the rear wheels are engaged, all wheels are engaged, and to what degree the wheels are oriented relative to a straight neutral orientation. Of course, embodiments in which friction based and/or regenerative braking systems are used to apply a braking force to the one or more wheels of a vehicle are also contemplated.

In a conventional railway, a wheel may only detect the rail as the wheel rides over it. Often there are no cameras or other sensors to help the wheel stay on the rail due to the use of rail flanges and other passive steering systems. In the present disclosure, the railway may be fixed and unchanging, such that all vehicles may receive and/or store information related to details of the layout of the railway including length, bank angle (cant), curvature, and incline. Of course, other parameters related to the railway may be relevant, and the disclosure is not limited in this regard. Thus, a processor of a control system of a vehicle may receive information related to the details of the railway ahead of the vehicle, including the above noted information, without use of cameras or other sensors by either receiving information transmitted from a remote server to the vehicle and/or recalling information stored in onboard memory to control steering of the bogie of a vehicle along a railway.

It should be noted that while exemplary embodiments are described herein as a grade-separated railway and make use of verticality in open air with a vehicle suspended below an associated rail, the present disclosure is not limited in this regard. For example, the systems and methods described herein may be employed for ground level railways, suspended railways, elevated railways, underground railways, and/or any other appropriate railway capable of supporting a vehicle as it travels along the rail. That is, the various elements of the railways described herein may allow subterranean railways to be constructed with the same or similar layout to the grade-separated railways described herein. As one example, the vehicles may be disposed on top of an underground rail (or suspended from an underground rail). Thus, a grade-separated railway may refer to any rail arrangement where the rails are located in different horizontal planes either above or below one another using any appropriate combination of one or more components located underground, above ground, and/or at grade (i.e. ground level). Additionally, while grade-separated railways are primarily discussed, ground-based implementations are contemplated. Accordingly, the railways described herein are not limited to use only with grade-separated railways with hanging vehicles. However, there are various advantages, including space and size, associated with a railway constructed to suspend a vehicle from the railway due to the ability to lower a vehicle to a ground level for boarding and/or other operations.

While a particular railway and rail construction are described above and depicted in the figures with a bogie located within a tubular rail, it should be understood that any appropriate railway and rail construction with a desired track arrangement for supporting the wheels of a bogie to support a connected vehicle may be used for the various embodiments described herein. Accordingly, even though the various embodiments are depicted as being used to suspend a vehicle beneath the rail with a bogie disposed within the rail, the disclosure is not limited to only this type of construction. Accordingly, any appropriate construction of a rail with the one or more desired tracks and associated bogie, or other drive system, may be used including for example: wheels captured in correspondingly shaped rails; guideways for an elevated and suspended vehicle where a bogie is enclosed within the guideway similar to the embodiment described above; a rail with a bogie enclosing a portion of the rail; and/or any other appropriate rail construction capable of supporting a vehicle in a desired orientation as it travels along a railway as the disclosure is not limited to any particular railway arrangement or construction. Thus, a railway may include one or more rails which may include one or more tracks formed on the rails to support the wheels of a bogie using any appropriate construction.

The disclosed vehicles and railways may be used in any appropriate application. For example, the disclosed systems and methods may be used to enable the transport of individual and/or high capacity vehicles. Additionally, the systems may be powered using any appropriate energy source including grid power via a power rail, on board power storage (e.g. batteries). Further, the system may be powered using renewable energy sources in some embodiments. For example, solar panels may provide energy to electric vehicles of the railway system, enabling an energy efficient and sustainable public transit option though any appropriate power source may also be used. Such a system may reduce dependence on automobiles, personal cars, or other individual vehicles.

As used herein, “vertical” is relative to a direction of local gravity. That is, a vertical plane is aligned with a local gravity vector, and moving up or down in this vertical plane is moving with or against the force of gravity. As used herein, “horizontal” refers to a direction of movement orthogonal to the vertical direction. In particular, a horizontal plane is perpendicular to the vertical plane, as defined by local gravity.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

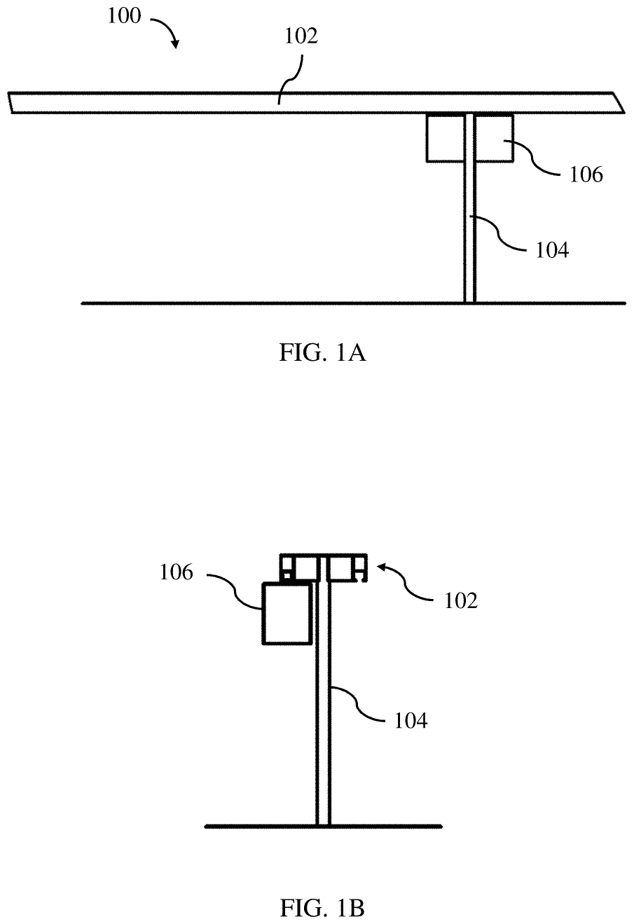

FIGS. 1A-1B depict one embodiment of an elevated railway 100. FIG. 1A shows a side view of an elevated railway 100, while FIG. 1B shows a front view. In this embodiment, the elevated railway 100 includes two rails 102. The two rails may enable transit in opposite directions. In some embodiments, a railway may include one, two, three, four, or any suitable number of rails, as the disclosure is not limited in this regard. In the embodiment of the figure, the rails 102 are supported by a post 104. Although only one post is shown, a railway may include a plurality of posts supporting a plurality of separate rails and/or rail segments to construct an overall railway as the disclosure is not limited in this regard. In the embodiment of the figures, the elevated railway 100 additionally includes a vehicle 106. Although only one vehicle is shown, a railway may include a plurality of vehicles that travel along the railway. Vehicles may be grouped together to form trains, and/or the vehicles may be operated independently such that they may be spaced apart along the railway.

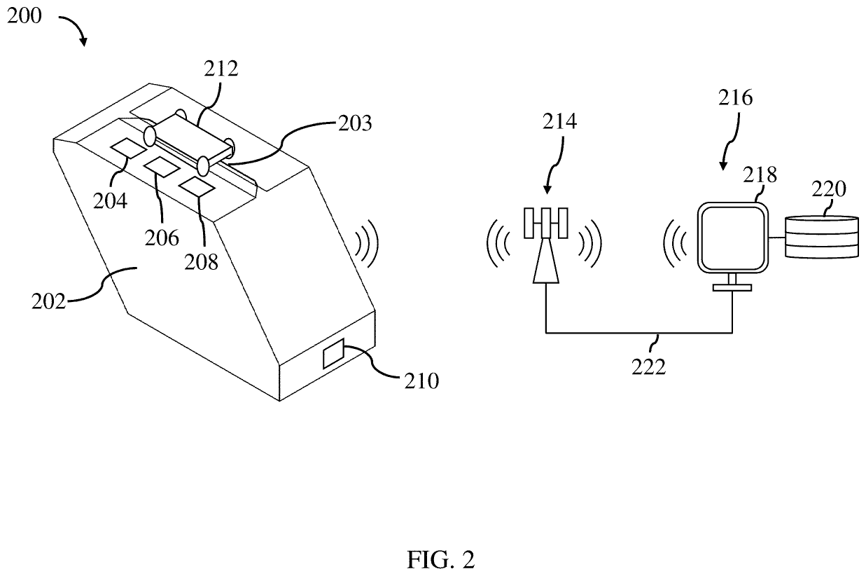

FIG. 2 is a schematic of one embodiment of a vehicle 200 (e.g., a pod) and a control system. As shown in FIG. 2, the vehicle includes a vehicle body 202 configured to carry one or more passengers. The vehicle includes a processor 204 configured to execute computer readable instructions stored in memory 206. The vehicle also includes a communications module 208 (e.g., a wireless transceiver) configured to allow the processor 204 to communicate with a central control system which is disposed remotely from the vehicle. The vehicle also includes at least one sensor 210 configured to collect information about the environment and provide the sensed information to the processor 204. For example, in one embodiment, the sensor 210 may include a radar or laser rangefinder for providing spacing information to the processor, a global positioning system (GPS) for location information, look ahead sensors for sensing information about the rail (e.g. cameras, laser rangefinders, radar, or other appropriate sensors), and/or any other desired sensor. The processor 204 may use such information to avoid collisions, control the speed of the vehicle, and/or control travel of the vehicle along a rail. According to the embodiment of FIG. 2, the vehicle includes a motorized bogie 212 which is configured to ride along an overhead rail with the vehicle body suspended below the bogie and rail. One or more motors configured to drive the wheels may be disposed in the bogie 212, and may be controlled by the processor 204 to control movement of the vehicle along a rail using any appropriate drive and/or steering systems, including the depicted motorized wheel bogie depicted in the figure. As shown in FIG. 2, the bogie is coupled to the vehicle body 202 via one or more central connections 203. Again, the bogie may be driven and steered along the rail and junctions between rails using any desired arrangement of active and/or passive steering systems including for example, actively steered bogie wheels, passive rail/wheel guidance, active switches at junctions, and/or any other appropriate steering arrangement as the present disclosure is not so limited.

As also illustrated in FIG. 2, a vehicle 200 may be controlled remotely by a remotely located central server 216. The remote server may include a central processor 218 (e.g., in a computer) and a database or memory 220. The central processor may be configured to execute one or more computer readable instructions stored on the memory 220. The remote server is configured to receive information from the vehicle 200 (e.g., from sensors 210). The remote server is also configured to transmit instructions to the vehicle 200 which may be interpreted by the vehicle processor 204. The central server may determine vehicle routes, speed, spacing, and/or any other suitable parameter. Communication between the remote server and the vehicle may be conducted using any suitable wireless or wired protocol (or a combination thereof). According to the embodiment shown in FIG. 2, the remote server may communicate to a communications tower 214, or other appropriate receiver, which functions as an intermediary relay between the remote server and the vehicle 200. In particular, the remote server communicates with the tower 214 via wireless communications and/or a wire 222. The tower 214 communicates with the vehicle 200 wirelessly and with a plurality of other vehicles that are all coordinated with the remote server 216. Of course, any suitable communications and control arrangement for a plurality of vehicles on a railway may be employed using either centralized control, localized control, a combination of both control strategies, and/or any other appropriate control strategy may be used as the present disclosure is not so limited.

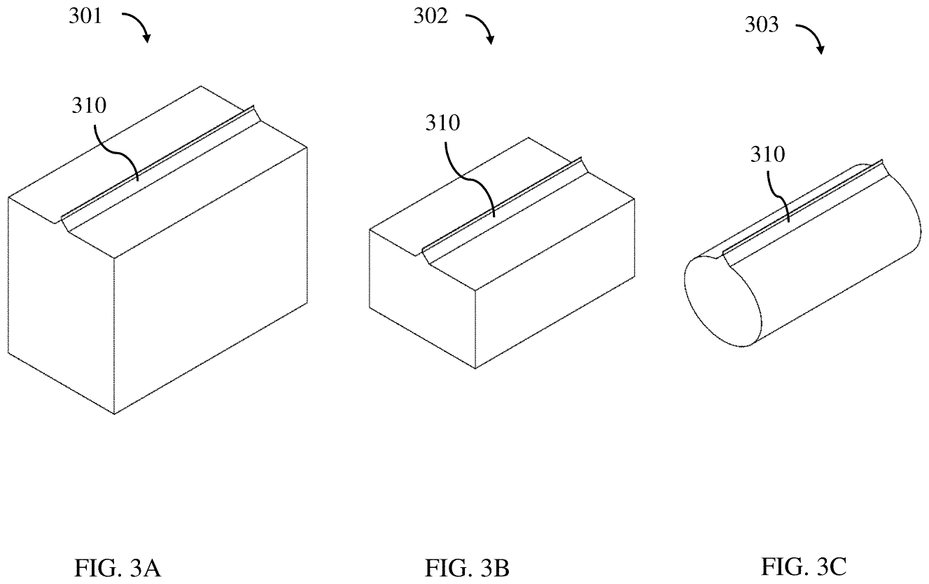

FIGS. 3A-3C are schematics of alternative embodiments 301, 302, and 303 of a vehicle body. Different vehicle bodies may have different shapes or sizes. For example, vehicle body 301 has a substantially square cross-sectional profile perpendicular to its longitudinal axis, while vehicle body 302 has a cross-sectional profile with a rectangular shape with a larger aspect ratio than vehicle body 301. Vehicle body 303 has a cross-sectional profile that is substantially circular. In some embodiments, a vehicle body may have a non-uniform profile. Accordingly, it should be understood that other vehicle body shapes and sizes are possible as the disclosure is not limited in this regard. Regardless, different vehicle bodies may, in some embodiments, include a common uniform connection 310 to enable the different vehicle bodies to couple to the same bogie. Consequently, a single bogie may be connected to multiple different vehicle bodies. Particular vehicle bodies may be selected for a particular application. For example, one vehicle body may be particularly suited for passengers, while another vehicle body may be particularly suited for cargo.

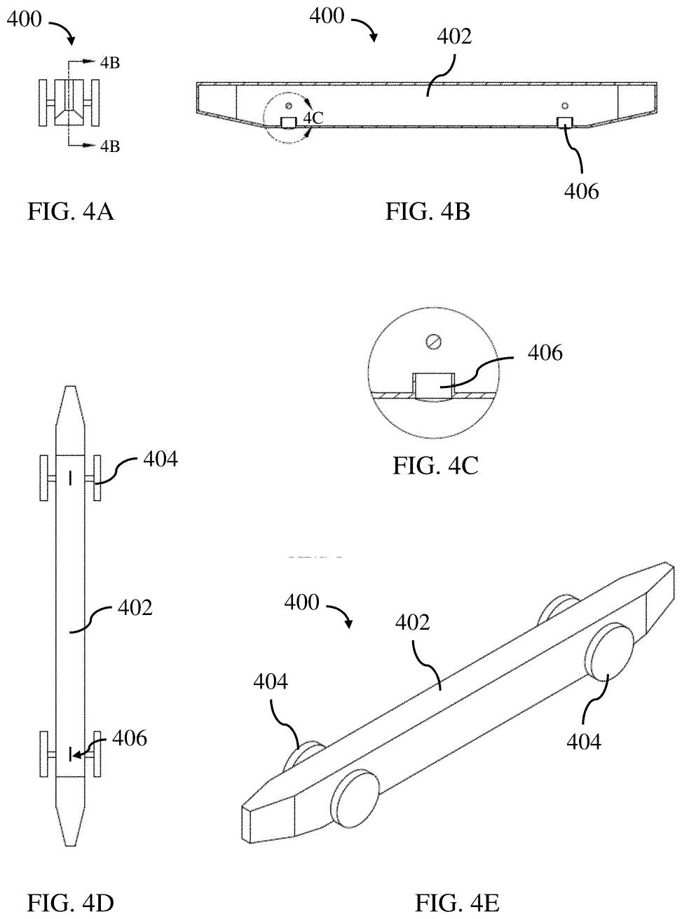

FIGS. 4A-4E show one embodiment of a bogie 400. A bogie 400 may include a body 402, one or more wheels 404, and one or more recesses 406. In the embodiment of the figure, bogie 400 includes an elongate body 402 and four wheels 404 arranged in pairs disposed on opposing sides of the bogie. Bogie 400 additionally includes two recesses 406. The recesses 406 may be configured to receive corresponding connections with a vehicle body, as described above in relation to FIGS. 2A-3C. Each recess 406 is disposed between one of the pair of wheels, as best seen in FIG. 4D. As such, in some embodiments, connections of a vehicle body may be aligned with wheels of the bogie along a longitudinal axis of the bogie. Though embodiments in which the recesses and/or other connection location between a vehicle and bogie is offset from, or located within some predefined distance from the axles or an axis extending between the wheel along the longitudinal length of the bogie are also contemplated as noted previously.

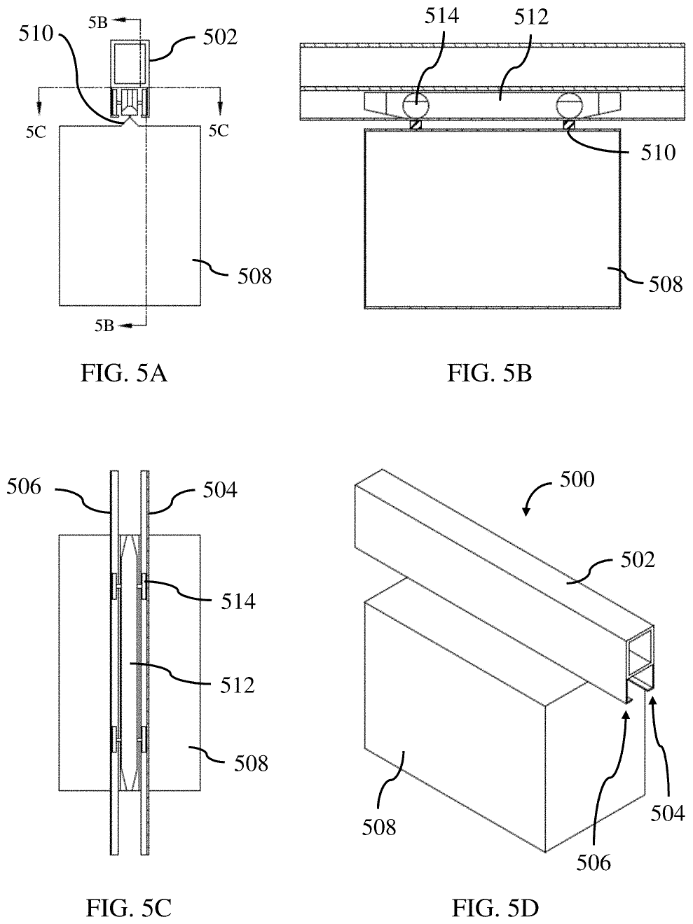

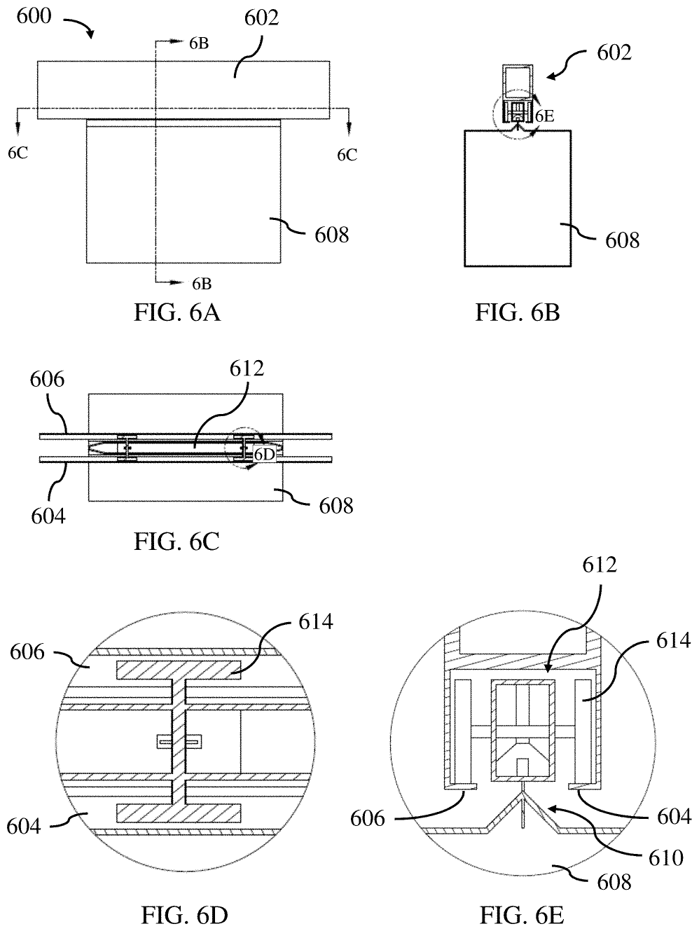

FIGS. 5A-6E show various views of different embodiments of portions of a railway. FIGS. 5A-5D show one embodiment of a portion of a railway 500. Railway 500 may include rail 502 and a vehicle. Rail 502 may include a right track 504 and left track 506 disposed on opposing sides of a slot extending along a length of the rail. The vehicle may include a vehicle body 508, bogie 512, and one or more connections 510 extending between the bogie and vehicle body. Bogie 512 may include a plurality of wheels 514 that are engaged with the associated tracks located on opposing sides of the bogie. FIGS. 6A-6E show another embodiment of a portion of a railway 600. Similar to the above, the railway 600 may include rail 602 and a vehicle. Rail 602 may include right track 604 and left track 606. The vehicle may include vehicle body 608, connection 610, and bogie 612. Bogie 612 may include a plurality of wheels 614.

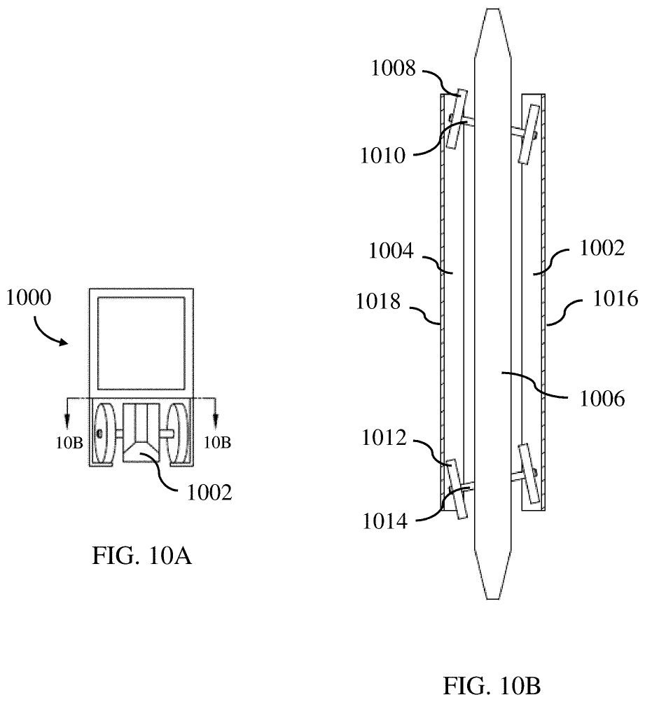

In some embodiments, a rail may be tubular. A cross-sectional profile of the rail may be substantially rectangular, as shown in the embodiments of FIGS. 5A-6E, or the cross section may have any other suitable shape as the disclosure is not so limited. For example, a cross-sectional profile of a rail may be circular. As best seen in FIGS. 6D-6E, tracks 604, 606 of rail 602 may define a bottom surface of an enclosed portion of rail 602. The enclosed portion of the rail may be configured to at least partially enclose the bogie 612 while permitting the connection 610 to the vehicle body 608 to extend out of the enclosure. Wheels 614 of bogie 612 may engage tracks 604, 606 of rail 602 located on opposing sides of the bogie. The wheel widths and/or track widths may be selected to ensure appropriate spacing on either side of a wheel when a wheel is engaged with a track. For example, sufficient spacing on the sides of the wheels when positioned on the track may enable a wheel to be steered along a length of the track. In one such embodiment, a wheel may be configured to steer on a track by maintaining a position along a centerline of a track, such as by attempting to equalize the spacing between each side of the wheel and the edges of the track. In some embodiments, a width of a track may be selected in part based on a size and/or shape of a protrusion of a wheel, as discussed in greater detail below in reference to FIGS. 10A-10B.

A slot may be disposed between right track 604 and left track 606 and extend along a length of the rail. The slot may enable connections 610 of the vehicle to extend through the slot to connect the vehicle body 608 located outside of the rail to the body of the bogie 612 located inside of the rail. The width of the slot may be selected to accommodate connections 610, both in straight sections of the railway and in curved sections of the railway. Without wishing to be bound by theory, a larger slot may allow a vehicle to achieve tighter turns. As best seen in FIG. 5B, connections 510 may be substantially aligned with wheels 514 of a bogie 512 along a longitudinal length of the bogie. However, in some embodiments, connections may be offset from the wheels of the bogie in a longitudinal direction. The spacing between the connections may be greater than, less than, or equal to the spacing of the wheels of the bogie, as the disclosure is not limited in this regard.

In some embodiments, a track may be L-shaped. As best seen in FIG. 6E, L-shaped tracks 604, 606 may extend perpendicularly inwards from the sidewalls of the rail 612. However, in some embodiments, one or more tracks of a rail may extend from a sidewall of a rail from an acute or an obtuse angle. In some embodiments, a track may be substantially tangent to a sidewall of a rail, such as in embodiments of a rail with a circular cross-sectional profile, wherein no defined transition between a track and a sidewall may be present. It should be appreciated that any track shape, width, and/or angle relative to a sidewall of a rail may be appropriate, as the disclosure is not limited in this regard.

In some embodiments, a rail may include a rail flange. A rail flange may include an L-shaped or wedge shaped structure. A rail flange may be disposed on one or more of the tracks of a rail, or may be disposed adjacent a sidewall of a rail. In some embodiments, an L-shaped track may function as a rail flange. In some embodiments, a dedicated rail flange may be used in addition to an L-shaped track. In some embodiments, no rail flanges may be included in a railway.

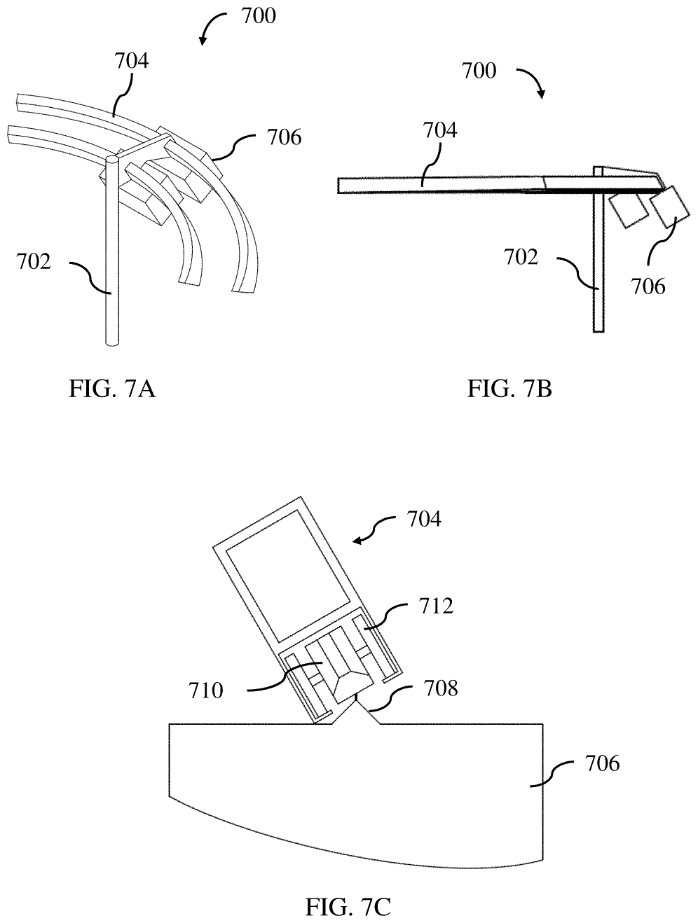

FIGS. 7A-7C show one embodiment of a banked turn 700 of a railway. Post 702 may support one or more rails 704 that may carry one or more vehicles using a rails and bogies similar to those described previously. As described above, a bogie 710 disposed within a rail 704 may be coupled to a vehicle body 706 through one or more connections 708. Connections 708 may be pivotably coupled to the bogie 710 such that the vehicle body 706 may rotate about an axis parallel to a longitudinal axis of the body of the bogie 710. As a vehicle rounds a banked turn 700 where the rails are angled off of the vertical direction, the pivotable coupling may allow the vehicle body 706 to move to an appropriate angle relative to vertical. This may include instances where the connection and vehicle body are angled relative to the bogie, i.e. rotated away from a 90 degree connection with the bogie. Depending on the speed, radius, and angle of the banked turn, the vehicle angle relative to vertical and the bogie. For example, slower larger radius turns may result in a vehicle remaining substantially vertical, as seen in FIG. 7C, while faster or sharper turns may result in the vehicle body being angled relative to vertical during the turn as shown in FIGS. 7A and 7B. This may be permitted due to the use of either a flexible connection 708 and/or a pivot axis that is used to couple the connection to the vehicle body and/or bogie.

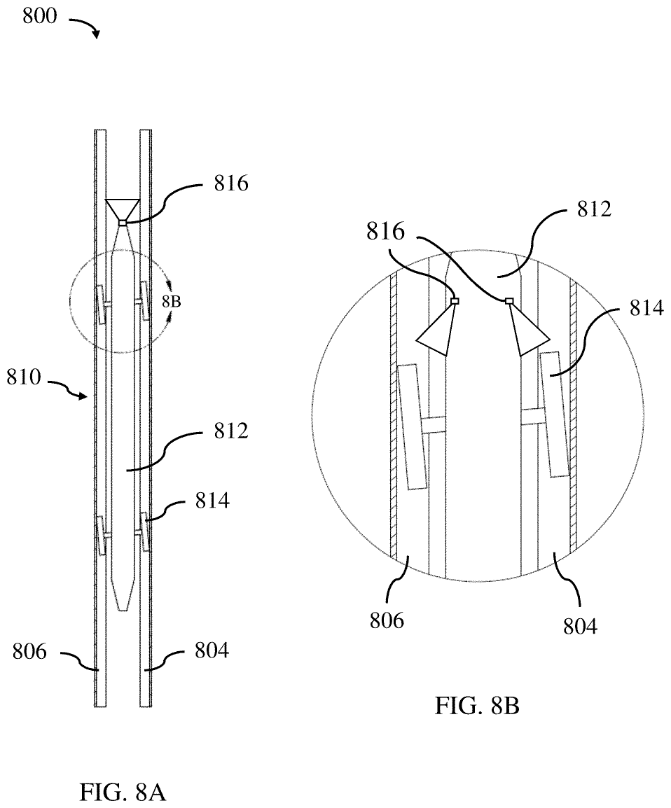

FIGS. 8A-8B show one embodiment of a bogie 810 with steerable wheels 814 on a portion of a railway 800. In the embodiment of the figure, bogie 810 includes a body 812, four wheels 814, and one or more sensors as illustrated by a sensor 816. Although shown as a single sensor in FIG. 8A, sensor 816 may include multiple sensors, such as the multiple sensors shown in FIG. 8B. For example, the figure illustrates the use of two sensors that are positioned forward of and directed towards the associated front wheel to monitor a position of the wheels on the associated tracks of the rail. Two wheels are arranged on a front axle near the front of the body 812, and two wheels are arranged on a rear axle near the rear of the body. One wheel of each of the pairs of wheels engages the right track 804 of the rail, and the other wheel of each of the pairs of wheels engages the left track 806 of the rail located on opposing sides of a slot located between the tracks of the rail. Sensor 816 may be configured to sense the position of the wheels 814 relative to the tracks 804, 806 and/or information about an upcoming portion of the rail located ahead of the bogie. In some embodiments, a first sensor may be configured to sense information about an upcoming portion of the rail, and one or more additional sensors may be configured to sense a position of an associated wheel relative to a track the wheel is disposed on. Information from the sensor 816 may be sent to a processor to determine the position of the wheels relative to a desired path of the wheels along the tracks of the rail. Based at least in part on any discrepancy between the actual positions and the desired positions of the wheels, and/or information about a section of the rail ahead of the bogie, the processor may send commands to adjust the positions of the wheels on the tracks. For example, a desired path of the wheels may include information regarding a desired offset from an edge of a track. In some embodiments, a desired path of a wheel may be a center of a track. Sensor 816 may sense an edge of a track and/or a position of a wheel relative to one or more edges of a track. Information from sensor 816 may be used in conjunction with information regarding a width of the track, a predetermined offset from the track edge, and/or other appropriate position information to maintain a wheel on a desired path of travel in order to maintain a position of a wheel in a desired position on the track, including, for example, a center of the track. Of course, in other embodiments, a wheel may be maintained at another desired offset from an edge of the track other than in the middle of the track. In the embodiment of FIGS. 8A-8B, the front and rear wheels are steerable. That is, the angle of the wheels 814 may be adjusted relative to the body 812 of the bogie 810. If the processor determines that the heading of one or more of the wheels should be adjusted, actuators associated with the axles and/or wheels may steer the wheels to adjust the heading of the wheels on the tracks. In some embodiments, multiple wheels may be coupled, such that changing the angle of one wheel may change the angle of at least one other wheel. For example, wheels on a single axle may be coupled through one or more push rods. However, in some embodiments, each wheel 814 of the bogie 810 may be independently controllable, such that the angle of each wheel relative to the body 812 of the bogie 810 may be set independently. While a single sensor has been shown to control a heading of the wheels in the figures, it should be understood that any number of sensors for sensing the position of the bogie and/or wheels relative to the one or more tracks of a rail may be used.

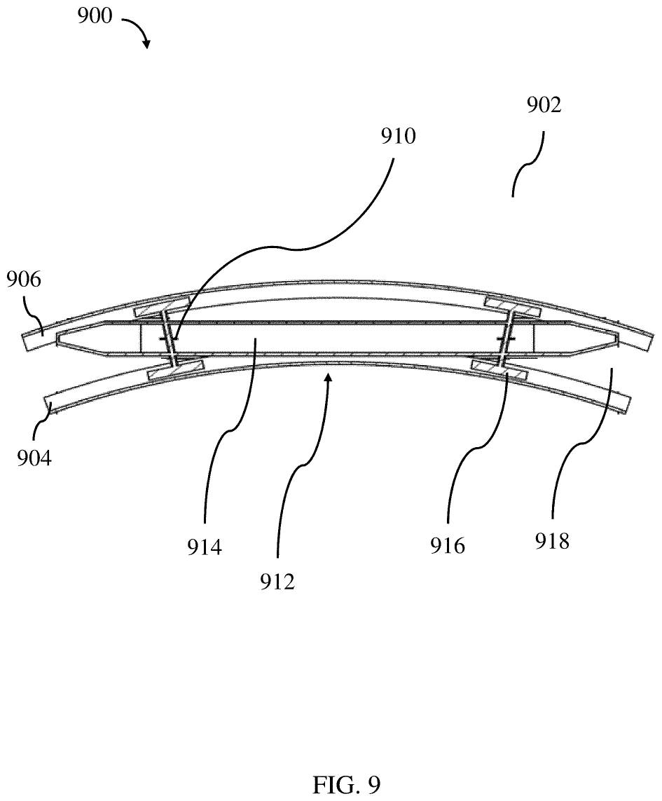

FIG. 9 is a top view of one embodiment of a bogie 912 on a horizontally curved rail 900 similar to that described above relative to FIGS. 5A-6E. Similar to the above, the bogie 912 may include an elongate body 914 and a plurality of wheels 916. Horizontally curved rail 900 may include a right track 904 and a left track 906 disposed on opposing side of a slot 918 extending along a length of the rail. As can be seen in the figure, the horizontal curvature of a rail that a bogie 912 may be able to transverse may be related to a length of the body 914 of the bogie. Without wishing to be bound by theory, a shorter bogie may be able to traverse a rail with a greater horizontal curvature compared to a longer bogie. Additionally, a width of the rail and the slot, as well as a minimum turn radius a bogie may be capable of traversing may be influenced by the connections 910 extending between the bogie and a vehicle, not shown. Specifically, if a long connection extending along the entire length of the bogie were used, the rail will either need to include a wide slot and/or large radius turns will need to be used to accommodate the presence of a long structure extending through the slot between the two separate connections 910 illustrated in the figure. Such a long continuous structure would include sections of the connection that would be displaced away from a center of the slot at locations located away from the wheels. In contrast, the two spaced apart and smaller connections 910 aligned with the wheel locations along a length of the bogie body permit the connections to be maintained in a central portion of the slot. This permits the use of a thinner rail, smaller slot, and/or tighter radius turns for a given bogie. Of course, it should be understood that while benefits may be associated with such a construction, other connections, including a single long connection along a length of a bogie body, may be used as the disclosure is not limited in this fashion.

FIGS. 10A-10B show one embodiment of a bogie 1006 in a parked configuration. To achieve a parked configuration, front wheels 1008 on front axle 1010 of the bogie 1006 may be turned in one direction, while rear wheels 1012 of rear axle 1014 may be turned in an opposite direction. If turned sufficiently, wheels disposed on right track 1002 may contact right sidewall 1016. Similarly, wheels disposed on left track 1004 may contact left sidewall 1018. In this way, the bogie 1006 may achieve a parked configuration where at least one wheel on the two opposing sides of the bogie may contact an adjacent rail flange, rail wall, or other structure to apply a braking force to the bogie and associated vehicle. A processor of the bogie, and/or a connected vehicle, may command the bogie to turn the wheels in the illustrated fashion to apply the noted braking force in situations where a typical braking strategy may be insufficient, undesired, and/or unavailable.

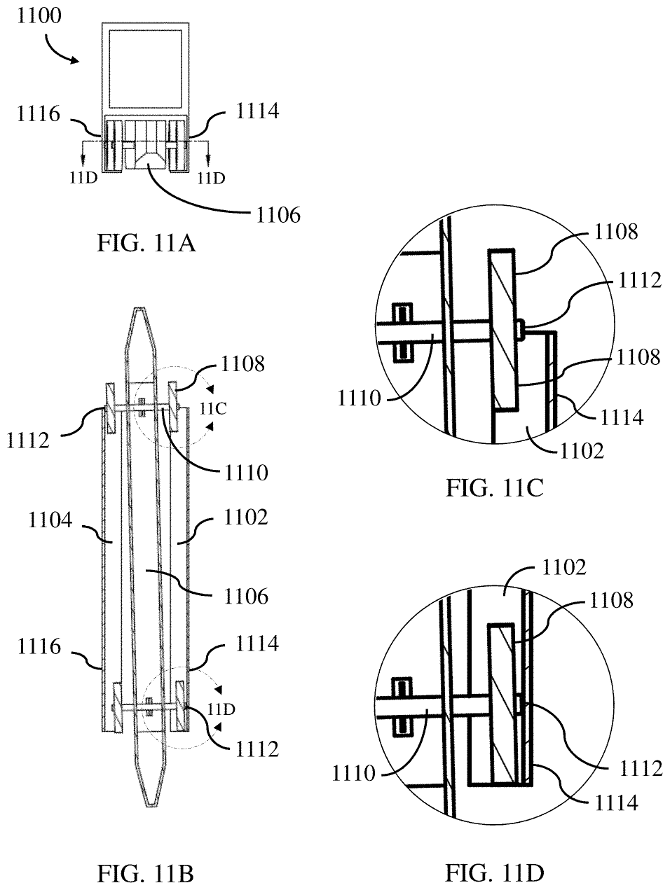

FIGS. 11A-11D show one embodiment of a bogie 1106 on a rail 1100 similar to that described above relative to FIGS. 5A-6E. The rail 1100 may include a right track 1102 and a left track 1104 disposed on an opposing side of a slot formed between the tracks and extending along a length of the rail. The rail may also include a right sidewall 1114 and a left sidewall 1116 located adjacent to the associated tracks. Bogie 1106 may be disposed within track 1100, such that wheels 1108 of the bogie are disposed on and engage the tracks 1102, 1104. As above, wheels 1108 of the bogie may be arranged on one or more axles 1110. In some embodiments, such as the embodiments of FIGS. 11A-11D, the axles 1110, or other structure, may extend laterally outwards beyond the end of the wheels 1108 in a direction oriented away from the bogie body to form one or more protrusions 1112 on each wheel. The protrusions 1112 may be configured to extend beyond the extent of the wheels such that the protrusions are configured to contact sidewalls 1114, 1116 before the wheels 1108 contact the sidewalls in some embodiments. As best seen in FIG. 11D, when protrusion 1112 contacts a sidewall (such as right sidewall 1114), wheel 1108 may remain out of contact with the sidewall when the wheels are oriented in a normal operating range of angular positions relative to the underlying track. This may reduce wear on the wheels and/or rail.

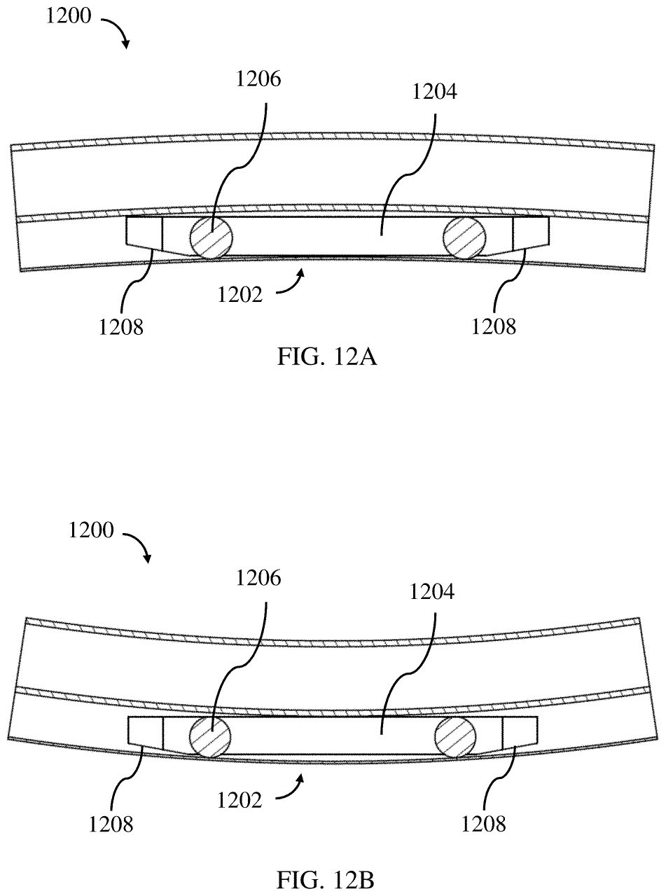

FIGS. 12A-12B show embodiments of a bogie 1202 on a rail 1200 which may be vertically curved upward (FIG. 12A) or vertically curved downward (FIG. 12B). Bogie 1202 may include an elongate body 1204 and a plurality of wheels 1206. As can be seen in the figure, the vertical curvature of a rail that a bogie 1202 may be able to transverse may be related to a length of the body 1204 of the bogie. Without wishing to be bound by theory, a shorter bogie may be able to traverse a rail with a greater vertical curvature compared to a longer bogie. Additionally, in some embodiments, a bogie may include upper and lower front and rear portions that included angled surfaces 1208 that are angled relative to a direction of travel to provide more clearance between the front and rear portions of the bogie and the upper and/or lower surfaces of a rail. This may permit a bogie to move along rails with smaller radii curves in the vertical direction while having a bogie with a somewhat longer profile in the longitudinal direction.

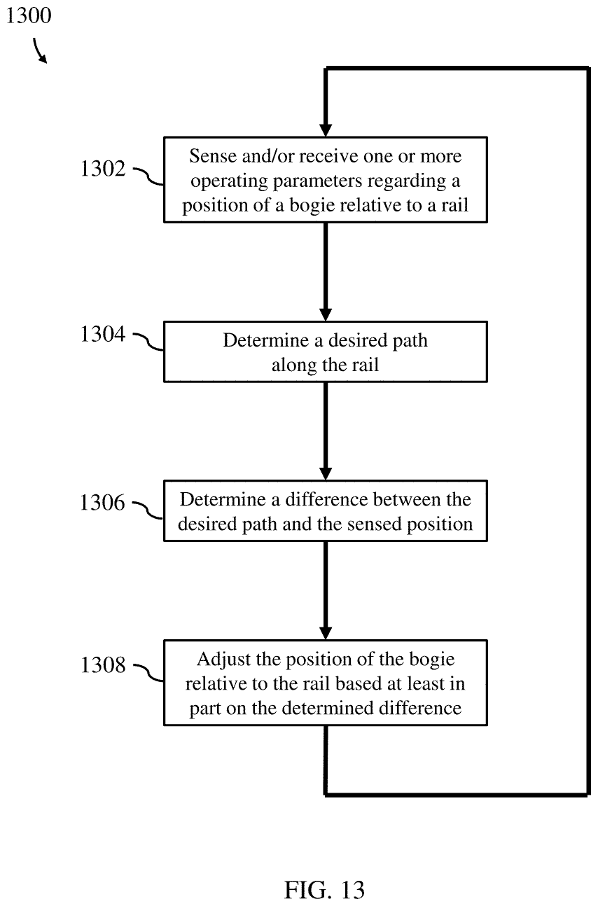

FIG. 13 is a flow chart for one embodiment of a method 1300 of controlling a vehicle. At block 1302, one or more operating parameters regarding a position of a bogie relative to a rail is sensed and/or received. For example, one or more sensors may sense a relative position of the wheels along the one or more tracks of a rail and/or information related to the rail may be received from a remotely located server. At block 1304, a desired path along the rail is determined. The desired path may be determined using any appropriate method including, for example, a path that extends along a predefined lateral location along a track width (e.g. a central portion of the track), through a turn when a bogie turns off of one rail onto another rail, and/or any other appropriate path a bogie vehicle might follow along a railway. At block 1306, a difference between the desired path and the sensed position is determined by comparing a sensed location of the bogie and/or wheels relative to the desired path along the associated track and/or rail. At block 1308, the position of the bogie relative to the rail is adjusted by steering the wheels of the bogie towards the desired path of the bogie based at least in part on the determined difference between the desired path and the sensed position of the bogie. After the position is adjusted, the process may repeat, sensing a parameter associated with the new position of the bogie. For example, a feedback loop may be implemented where the magnitude and direction of a difference from a desired path may be used to continuously steer the wheels of a bogie to maintain the bogie on a desired path along the tracks of a rail as the bogie moves along the rail.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single device or distributed among multiple devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semicustom or custom. As a specific example, some commercially available microprocessors have multiple cores such that one or a subset of those cores may constitute a processor. Though, a processor may be implemented using circuitry in any suitable format.

The various processors disclosed herein may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A vehicle comprising:
a bogie including at least a first wheel and a second wheel coupled to a body of the bogie, wherein the first and second wheels are configured to engage with opposing tracks extending along a length of a railway as the bogie travels along the railway;
at least one look ahead sensor configured to sense a position of the bogie relative to the tracks of the railway;
a vehicle body coupled to a bottom of the bogie body such that the vehicle body is configured to be suspended below the railway; and
a processor configured to receive the sensed position of the bogie relative to the tracks of the railway from the at least one look ahead sensor, wherein the processor is configured to determine a desired path of the first wheel and the second wheel on the tracks of the railway as the bogie travels along the railway based at least in part on the sensed position of the bogie relative to the tracks of the railway.

2. The vehicle of claim 1, wherein the processor is further configured to steer the first and second wheels along the desired path.

3. The vehicle of claim 2, wherein the angles of the first and second wheels relative to the bogie body are adjustable, and wherein the processor is configured to steer the first and second wheels by selectively adjusting the angles of the first and second wheels.

4. The vehicle of claim 2, wherein speeds of the first and second wheels are individually controllable, and wherein the processor is configured to steer the first and second wheels by selectively adjusting the speeds of the first and second wheels.

5. The vehicle of claim 1, wherein the railway is an elevated railway.

6. The vehicle of claim 1, wherein the at least one look ahead sensor is configured to sense a geometry of the railway.

7. The vehicle of claim 6, wherein the geometry of the railway includes a curvature of the railway.

8. The vehicle of claim 6, wherein the geometry of the railway includes an edge of at least one of the tracks.

9. The vehicle of claim 1, wherein the at least one look ahead sensor is configured to sense a position of at least one of the first and second wheels relative to the associated track with which the at least one of the first and second wheels is engaged.

10. The vehicle of claim 1, wherein the at least one look ahead sensor includes one or more selected from the group of a camera, a distance sensor, and a magnetic sensor.

11. The vehicle of claim 1, further comprising at least one protrusion disposed on and extending outward from at least one of the first and second wheels and the bogie.

12. The vehicle of claim 1, wherein the bogie further comprises a third wheel and a fourth wheel coupled to the body of the bogie, wherein the third and fourth wheels are configured to engage with the opposing tracks extending along the length of the railway as the bogie travels along the railway.

13. The vehicle of claim 12, wherein the first and second wheels are coupled by a first axle, and wherein the third and fourth wheels are coupled by a second axle.

14. The vehicle of claim 13, wherein the first and second axles are individually steerable.

15. A method of controlling a vehicle, the method comprising:
sensing a position of at least one wheel of the vehicle relative to at least one track of a railway on which the at least one wheel is disposed as the vehicle travels along the railway;
determining a desired path of the at least one wheel along the at least one track; and
steering the at least one wheel along the desired path as the vehicle travels along the railway.

16. The method of claim 15, wherein steering the at least one wheel along the desired path includes adjusting an angle of the at least one wheel relative to the vehicle.

17. The method of claim 15, wherein steering the at least one wheel along the desired path includes adjusting a speed differential between at least two wheels of the at least one wheel.

18. The method of claim 15, wherein sensing the position of the at least one wheel of the vehicle relative to the at least one track of the railway includes sensing a curvature of the railway.

19. The method of claim 15, wherein sensing the position of the at least one wheel of the vehicle relative to the at least one track of the railway includes sensing an edge of the at least one track.

20. The method of claim 15, wherein steering the at least one wheel along the desired path includes steering the at least one wheel along the desired path based at least in part on information regarding the railway received from a remotely located central server.

21. The method of claim 20, wherein steering the at least one wheel along the desired path based at least in part on information regarding the railway includes steering the at least one wheel along the desired path based at least in part on one or more selected from the group of railway length, railway cant, railway curvature, and railway incline.

22. The method of claim 15, wherein determining the desired path includes determining the center of the at least one track.

23. A vehicle comprising:
a bogie configured to engage a railway;
a vehicle body; and
at least two connections extending between a top surface of the vehicle body and an opposing bottom surface of the bogie such that the vehicle body is suspended below the bogie when the bogie is engaged with the railway, wherein the at least two connections are spaced apart along a longitudinal length of the bogie.

24. The vehicle of claim 23, wherein the bogie includes an elongated body and at least two sets of wheels located on opposing sides of the body of the bogie.

25. The vehicle of claim 24, wherein the at least two connections are aligned with axes of the at least two sets of wheels along the longitudinal length of the bogie.

26. The vehicle of claim 23, where each of the at least two connections is configured to pivot relative to the bogie about an axis parallel to the longitudinal axis of the bogie such that the vehicle body rolls about the axis.
